(19) United States
(12) Patent Application Publication
(10) Pub. No.: US 2008/0184059 A1
(43) Pub. Date: Jul. 31, 2008

(54) Dual redundant server system for transmitting packets via linking line and method thereof

(75) Inventor: Chih-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/699,382

(22) Filed: Jan. 30, 2007

(51) Int. Cl. G06F 11/20

(52) U.S. Cl. 714/4; 714/E11.073

(57) ABSTRACT

The present invention discloses a dual redundant server system for transmitting packets via a linking line. The server system includes a primary server and a standby server, and the linking line is installed between the primary server and the standby server and the primary server continuously produces a heartbeat packet. If there is any change of data in the primary server, the primary server will produce a mirror packet. The heartbeat packet or mirror packet is transmitted to the standby server through the linking line. If the standby server receives no heartbeat packet or mirror packet transmitted from the primary server within a set period of time, then the standby server will take over the primary server.

### FIELD OF THE INVENTION

The invention relates to server systems, and more particularly, to a dual redundant server for transmitting packets via a linking line, and the method thereof.

### DESCRIPTION OF PRIOR ART

In a technologically advanced world we have today, the booming electronic industry constantly introduces various hi-tech products and mobile communication technology to the public, which have not only gradually integrated into our daily lives, but also greatly reduced the spatial and temporal distances between people. As the electronic products (such as computers) and communication technology (such as the Internet) become more and more popularized, and different incentives are introduced by the manufacturers, the competition for new users have only turned more intense. As a result, the major manufacturers are constantly unveiling new products in an attempt to win the consumers' hearts and minds with even more novel and ingenious products. Because consumers are demanding better electronic products and communication technology all the time, it is important that the electronic products and communication technology introduced in the future can provide better and faster services for the consumers, and this has become a crucial criterion in deciding whether a country is more technologically advanced than other countries or not.

The servers are high-performance computers, and are mainly used as gateways in networks that allow users to access the data of networks. Generally, a server comprises at least a processor, a hard drive, a memory unit, and cables for interlinking the system. These components are specifically designed for applications in networks, and they impart the server with higher performance, reliability, and security, while also make the server easily expandable and manageable. As the information technology continues to move forward and the demand for flow of data keeps growing, the use of servers in general companies or organizations for providing information, download and mail services has become more common, and the ability to offer more stable and convenient data sources and services have become intricately related to the processing capability and stability of servers.

In response to interruption of data access or network services resulted from various anomalies in the servers, a type of dual redundant server system has been developed. Such a system comprises a master controller and a slave controller, in which the master controller transmits or receives data packets between the server system and a network, thereby allowing the server system to transmit and receive data packets to and from the network (for example, exchanges of information, downloads, and mails). Moreover, to prevent the server system from being interrupted due to any anomalies in the master controller, the master controller transmits a heartbeat packet to the slave controller at a set interval under normal operation. As soon as the slave controller receives the heartbeat packet within the set interval, it clears and restarts the timing, and continues to detect if the heartbeat packet is received within the set interval in every round of timing. If any anomalies occur in the master controller and consequently prevents the transmission of the heartbeat packet to the slave controller within the set interval, the slave controller immediately takes over the master controller, so that the transmission and reception of data packets between the server system and the network can continue.

However, a common problem is observed in the dual redundant server systems of prior art, which takes place when the slave controller takes over the master controller even if there is no anomaly or malfunction in the master controller, and subsequently leads to conflict between the master controller and the slave controller. The underlying cause for such conflict is that excessive amount of data is transmitted between the master controller and the slave controller when mirroring process takes place, and thus hindering the heartbeat packet from reaching the slave controller in time. As a result, the slave controller misinterprets the situation and conflicts with the master controller. This not only impedes the normal transmission and reception of data packets between the server system and the network, it may also lead to damage or loss of data of the server system.

### SUMMARY OF THE INVENTION

In light of the problem of conflicting controllers, resulted from the failure of delivering the heartbeat packet within a set interval in the dual redundant server system of prior art, a dual redundant server system for transmitting packet by linking line and method thereof are disclosed in the invention.

A primary objective of the invention is to propose a dual redundant server system for transmitting packet by linking line; the server system includes a primary server for continuously transmitting a heartbeat packet, and if there is any change of data in the primary server, the primary server also produces a mirror packet and transmits it to a standby server. The server system also includes a standby server, and a linking line disposed between the primary server and the standby server. When transmitting the heartbeat packet or the mirror packet, it travels through the linking line and subsequently reaches the standby server. After a set period of time, the standby server determines if itself has received the heartbeat packet or the mirror packet; if neither the heartbeat packet nor the mirror packet is received within the set period of time, the standby server is allowed to take over the primary server. Therefore, problems like conflicting servers, as well as any damage or loss of data in the server system can be effectively eliminated.

Another objective of the invention is to propose a method for supporting the server system. The server system has a primary server that continuously transmits a heartbeat packet to a standby server that is also included in the server system. If there is any change of data in the primary server, the primary server produces and subsequently transmits a mirror packet to the standby server. After a set period of time, if the standby server determines it has received no heartbeat packet or mirror packet within the set period of time, the standby server would take over the primary server. As a result, it can prevent the standby server from taking over the primary server when the primary server is still working normally, and further prevent the servers from conflicting with each other.

### BRIEF DESCRIPTION OF DRAWINGS

The foregoing aspects, as well as many of the attendant advantages and features of this invention will become more apparent by reference to the following detailed description, when taken in conjunction with the accompanying drawings, wherein:

FIG. 1 shows the dual redundant server system according to the invention;

FIG. 2 is a flow chart showing the steps of the method according to the invention; and

FIG. 3 is a flow chart showing the process of determining the status of the live flag according to the invention.

### DETAILED DESCRIPTION OF PREFERRED EMBODIMENTS

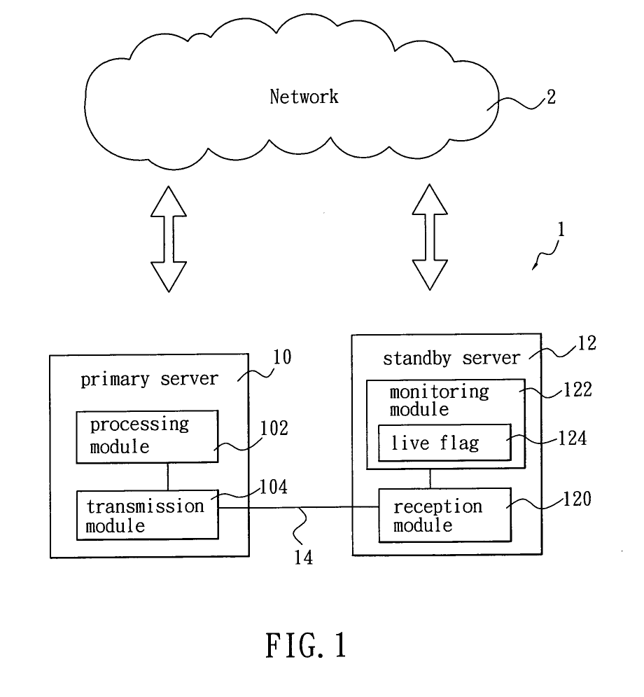

The invention discloses a dual redundant server system that uses a linking line for transmitting packets. FIG. 1 shows a server system 1 that comprises a primary server 10, a standby server 12, and a linking line 14 (such as an Ethernet cable). The primary server 10 continuously produces a heartbeat packet and transmits the heartbeat packet via the linking line 14 to the standby server 12. If there is any change of data in the primary server 10, the primary server 10 produces a mirror packet and transmits the mirror packet via the linking line 14 to the standby server 12. After a set period of time, the standby server 12 begins to detect if the standby server 12 has received the heartbeat packet or the mirror packet; if the standby server 12 received no heartbeat packet or mirror packet, the standby server 12 would take over the primary server 10. Therefore, problems resulted from transmitting excessive amount of data in the mirror packet can be prevented, such as lost heartbeat packets or the reception of heartbeat packet only after the set period of time, which causes the standby server 12 to misinterpret an anomaly situation in the primary server 10 and forces the standby server 12 to take over the primary server 10 mistakenly.

In a preferred embodiment of the invention, as shown in FIG. 1, the primary server 10 comprises at least a processing module 102 and a transmission module 104, in which the processing module 102 is used to continuously produce and transmit the heartbeat packet to the transmission module 104. If there is any change of data in the primary server 10, the changed data is transformed into the mirror packet and subsequently transmitted to the transmission module 104. The mirror packet can be of mirror commands, data, or status. The transmission module 104 is connected to the processing module 102 at one end and to the linking line 14 at the other end, and when the transmission module 104 receives the heartbeat packet or the mirror packet, the transmission module 104 transmits the packets via the linking line 14 to the standby server 12. Consequently, all changes of data in the primary server 10 can be backed up to the standby server 12.

In the preferred embodiment, referring to FIG. 1, the standby server 12 comprises at least a reception module 120 and a monitoring module 122, in which the reception module 120 is connected to the other end of the linking line 14 at one end and to the monitoring module 122 at the other end, and receives the heartbeat packet or the mirror packet. After a set period of time, if the monitoring module 122 detects the reception module 120 has not received the heartbeat packet or the mirror packet within the set period of time, the monitoring module 122 would make the standby server 12 take over the primary server 10, so that the standby server 12 can replace the primary server 10 to connect to a network 2 and obtain the identity of the primary server 10 for accessing packets from the network 2. Therefore, any anomalies or malfunctioning of the primary server 10 can be precisely determined, and thus the primary server 10 can be quickly replaced in order to shorten the interruption of the server system 1.

In the preferred embodiment, referring to FIG. 1 again; the monitoring module 122 includes a live flag 124. When the reception module 120 receives the heartbeat packet or the mirror packet, the monitoring module 122 sets the live flag 124 to be in a live status; the status of the live flag 124 serves to indicate if there is any anomaly or malfunction in the primary server 10. After the set period of time, if the live flag 124 remains in the live status, the monitoring module 122 sets the live flag 124 to a clear status. However, if the reception module 120 receives the heartbeat packet or the mirror packet again, the monitoring module 122 sets the live flag 124 to be in the live status. In summary, if the status of the live flag cycles between live and clear continuously, it indicates there is no anomaly or malfunction in the primary server 10.

After the set period of time, if the monitoring module 122 determines the live flag 124 is set to be in the clear status, it means the standby server 12 did not receive the heartbeat packet or the mirror packet within the set period of time. In other words, there is anomaly or malfunction in the primary server 10, and whether the heartbeat packet is lost or delayed has become irrelevant at this stage. Subsequently, the monitoring module 122 makes the standby server 12 take over the primary server 10, and thus the problem of the standby server mistakenly taking over the primary server can be prevented, which in turn significantly increasing the stability of the server system 1.

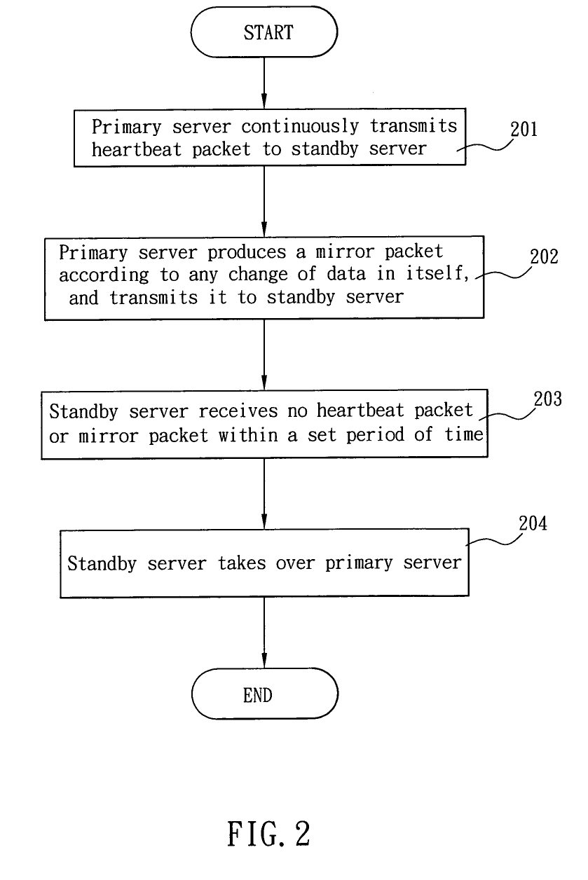

Referring to FIG. 1 and FIG. 2, the invention also discloses a method for supporting server systems. The method is applied to a server system 1 that comprises a primary server 10 and a standby server 12; the primary server 10 continuously transmits a heartbeat packet to the standby server 12, and if there is any change of data in the primary server 10, the primary server 10 produces and subsequently transmits a mirror packet to the standby server 12. After a set period of time, if the standby server 12 determined it has received no heartbeat packet or the mirror packet within the set period of time, the standby server 12 would take over the primary server 10. As a result, even if the heartbeat packet is transmitted to the standby server 12 late due to excessive amount of data in the mirror packet, the reception of the mirror packet ensures that the standby server 12 would not erroneously determines there is anomaly in the primary server 10 and takes over it.

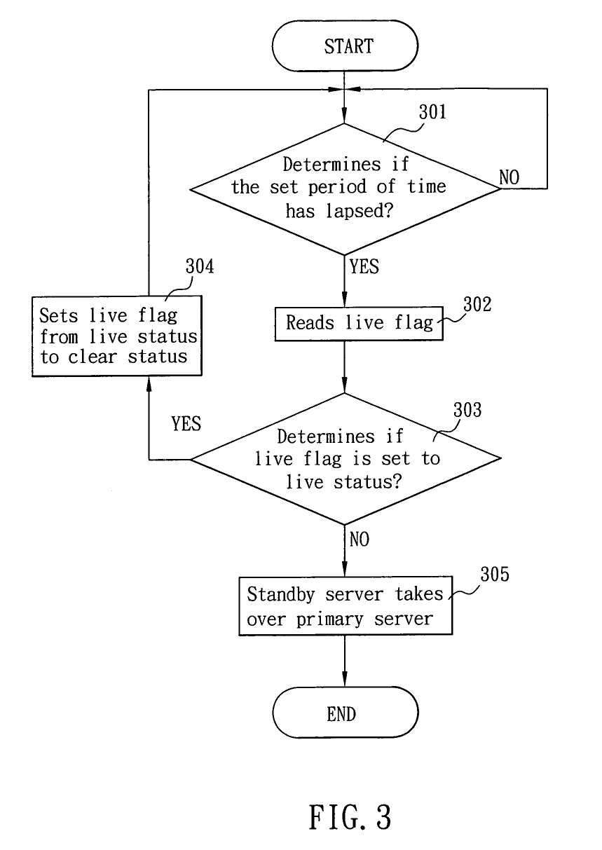

Referring to FIG. 2, the steps in the method of the invention are described in details below:
(201) The primary server 10 continuously transmits the heartbeat packet to the standby server 12.
(202) The primary server 10 produces and subsequently transmits the mirror packet to the standby server 12 when there is any change of data in the primary server 10. In the invention, the primary server 10 and the standby server 12 are mutually interlinked by a linking line 14, so that the heartbeat packet and the mirror packet can be transmitted to the standby server 12 via the linking line 14. Consequently, it is not necessary to transmit the heartbeat packet via a network 2, thereby preventing the standby server 12 from erroneously determining there is anomaly in the primary server 10 and taking over the primary server 10. Moreover, the linking line 14 can be an Ethernet cable, and the mirror packet can be of mirror commands, data, or status.
(203) After the set period of time, the standby server 12 determines whether on not the standby server 12 has received the heartbeat packet or mirror packet. In the preferred embodiment of the invention, before the set period of time is up, the standby server 12 can receive the heartbeat packet or the mirror packet transmitted from the primary server 10 at any time, and when the standby server 12 receives the heartbeat packet or the mirror packet, the standby server 12 sets a live flag 124, which is stored in the standby server 12, from the clear status to the live status. As a result, the standby server 12 can determine if itself has received the heartbeat packet or the mirror packet within the set period of time by relying on the status of the live flag 124. Referring to FIG. 3, by relying on the status of the live flag 124, the standby server 12 can determine if itself has received the heartbeat packet or the mirror packet within the set period of time, and whether to take over the primary server 10 or not according to the following steps:
   (301) determining if the set period of time has lapsed; if it has, going to step (302), otherwise step (301) is repeated;
   (302) reading the live flag 124;
   (303) determining if the live flag 124 is set to be in the live status; if it is, going to step (304), otherwise going to step (305);
      Therefore, it can be determined whether the standby server 12 has received the heartbeat packet or the mirror packet within the set period of time or not, thereby allowing the standby server 12 to determine if it is necessary to take over the primary server 10.
   (304) setting the live flag 124 from the live status to the clear status, and then going to step (301); and
   (305) taking over the primary server 10 by the standby server 12.
   Consequently, it is possible to decide if the primary server 10 is operating normally by determining whether the live flag 124 is set to be in the live status or clear status. If there is any anomaly in the primary server 10, the primary server 10 can be quickly replaced by the standby server 12, and this method also effectively eliminates the problem of mistakenly taking over the primary server 10 due to errors.
(204) The standby server 12 takes over the primary server 10. In the embodiment, when the standby server 12 takes over the primary server 10, it is set up in accordance with the configuration data of the primary server 10, so that the standby server 12 replaces the primary server 10 and connects to the network 2, thereby obtaining the network identity of the primary server 10 for accessing the network packets. Consequently, the interruption of the server system 1 resulted from a malfunctioning primary server 10 can be significantly reduced.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A dual redundant server system for transmitting packets via linking line, comprising:
a primary server for continuously producing a heartbeat packet, in which a mirror packet is also produced when there is any change of data in the primary server;
a standby server for receiving said heartbeat packet or said mirror packet;
when said standby server receives no heartbeat packet or mirror packet transmitted from the primary server within a set period of time, said standby server takes over the primary server; and
a linking line disposed between said primary server and said standby server, for transmitting said heartbeat packet or said mirror packet.

2. The server system of claim 1, wherein said primary server comprises:
a processing module for continuously producing said heartbeat packet; when there is any change of data in the primary server, said processing module subsequently turn the changed data into said mirror packet; and
a transmission module connected between said processing module and one end of said linking line, said transmission module receives and subsequently transmits said heartbeat packet or said mirror packet via said linking line to said standby server.

3. The server system of claim 2, wherein said standby server comprises:
a reception module connected to the other end of said linking line, which receives said heartbeat packet or said mirror packet; and
a monitoring module connected to said reception module, which determines whether or not said reception module has received said heartbeat packet or said mirror packet within a set period of time; if not, said monitoring module makes said standby server take over the primary server.

4. The server system of claim 3, wherein said monitoring module includes a live flag, and said monitoring module sets said live flag to be in a live status when said monitoring module receives said heartbeat packet or said mirror packet.

5. The server system of claim 4, wherein said monitoring module sets said live flag to be in a clear status when said live flag remains in the live status after a set period of time.

6. The server system of claim 5, wherein said monitoring module makes said standby server take over the primary server when said live flag remains in the clear status after a set period of time.

7. The server system of claim 4, wherein said linking line is an Ethernet cable.

8. A method for supporting redundant server system consisting of a primary server and a standby server, comprising the steps of:
said primary server continuously transmitting a heartbeat packet to said standby server;
said primary server producing a mirror packet in accordance with any change of data in said primary server and then transmitting said mirror packet to said standby server; and
the standby server taking over said primary server when said standby server receives no heartbeat packet or mirror packet from said primary server within a set period of time.

9. The method of claim 8, before said set period of time lapses, further comprises the steps of:
said standby server receiving said heartbeat packet; and
said standby server setting a live flag stored therein from a clear status to a live status.

10. The method of claim 8, before said set period of time lapses, further comprises the steps of:
said standby server receiving said mirror packet; and
said standby server setting a live flag stored therein from a clear status to a live status.

11. The method of claim 9, when said standby server receives no heartbeat packet or mirror packet within said set period of time, further comprises the steps of:
said standby server reading said live flag; and
said standby server setting said live flag to the clear status.

12. The method of claim 10, when said standby server receives no heartbeat packet or mirror packet within said set period of time, further comprises the steps of:
said standby server reading said live flag; and
said standby server setting said live flag to the clear status.

13. The method of claim 11, when said standby server receives said heartbeat packet or said mirror packet within said set period of time, further comprises the steps of:
said standby server reading said live flag; and
said standby server setting said live flag to the live status.

14. The method of claim 12, when said standby server receives said heartbeat packet or said mirror packet within said set period of time, further comprises the steps of:
said standby server reading said live flag; and
said standby server setting said live flag to the live status.

15. The method of claim 13, said standby server receives said heartbeat packet or said mirror packet within said set period of time, further comprises the step of:
said standby server setting said live flag from the live status to the clear status.

16. The method of claim 14, said standby server receives said heartbeat packet or said mirror packet within said set period of time, further comprises the step of:
said standby server setting said live flag from the live status to the clear status.
